(19) United States
(12) Patent Application Publication
(10) Pub. No.: US 2022/0240576 A1
(43) Pub. Date: Aug. 4, 2022

(54) Encased Battery Cell of a Vaporizer Device

(71) Applicant: JUUL Labs, Inc., San Francisco, CA (US)

(72) Inventors: Jie Guan, Morgan Hill, CA (US); Val Valentine, San Francisco, CA (US); Tianren Xu, Cupertino, CA (US); Qingcheng Zeng, San Jose, CA (US)

(21) Appl. No.: 17/725,415

(22) Filed: Apr. 20, 2022

Related U.S. Application Data
(63) Continuation of application No. PCT/US20/57038, filed on Oct. 23, 2020.
(60) Provisional application No. 62/925,053, filed on Oct. 23, 2019.

(51) Int. Cl. A24F 40/40; H01M 50/169; H01M 50/543; H01M 10/04; A24F 40/70

(52) U.S. Cl. CPC A24F 40/40; H01M 50/169; H01M 2220/30; H01M 10/0431; A24F 40/70; H01M 50/543

(57) ABSTRACT

A vaporization device includes a power source comprising a shell including a hermetic chamber. The hermetic chamber having an anode, an anode current collector, a cathode, a cathode current collector, a separator, and an electrolyte disposed therein. The hermetic chamber including the anode, the anode current collector, the cathode, the cathode current collector, and the electrolyte forming a battery serving as a power source for the vaporizer device.

### TECHNICAL FIELD

The subject matter described herein relates to vaporizer devices, including a power source.

### BACKGROUND

Vaporizer devices, which can also be referred to as vaporizers, electronic vaporizer devices or e-vaporizer devices, can be used for delivery of an aerosol (or “vapor”) containing one or more active ingredients by inhalation of the aerosol by a user of the vaporizing device. For example, electronic cigarettes, which may also be referred to as e-cigarettes, are in a class of vaporizer devices that are typically battery powered and that may be used to simulate the experience of cigarette smoking, but without burning of tobacco or other substances.

In use of a vaporizer device, the user inhales an aerosol, commonly called vapor, which may be generated by a heating element that vaporizes (which generally refers to causing a liquid or solid to at least partially transition to the gas phase) a vaporizable material, which may be liquid, a solution, a solid, a wax, or any other form as may be compatible with use of a specific vaporizer device. The vaporizable material used with a vaporizer can be provided within a cartridge (e.g., a part of the vaporizer that contains the vaporizable material in a reservoir) that includes a mouthpiece (e.g., for inhalation by a user).

To receive the inhalable aerosol generated by a vaporizer device, a user may, in certain examples, activate the vaporizer device by taking a puff, by pressing a button, or by some other approach. A puff, as the term is generally used (and also used herein), refers to inhalation by the user in a manner that causes a volume of air to be drawn into the vaporizer device such that the inhalable aerosol is generated by a combination of vaporized vaporizable material with the air.

A typical approach by which a vaporizer device generates an inhalable aerosol from a vaporizable material involves heating the vaporizable material in a vaporization chamber (or a heater chamber) to cause the vaporizable material to be converted to the gas (or vapor) phase. A vaporization chamber generally refers to an area or volume in the vaporizer device within which a heat source (e.g., conductive, convective, and/or radiative) causes heating of a vaporizable material to produce a mixture of air and vaporized vaporizable material to form a vapor for inhalation by a user of the vaporization device.

Currently available vaporizers often use a power source such as a lithium-ion battery. Lithium-ion batteries may be useful due to their power density and high discharge rates. Often, portable vaporizer devices compromise between device size and battery life. As such, improved vaporization devices and/or vaporization cartridges that improve upon or overcome these issues is desired.

The term vaporizer device, as used herein consistent with the current subject matter, generally refers to portable, self-contained, devices that are convenient for personal use. Typically, such devices are controlled by one or more switches, buttons, touch sensitive devices, or other user input functionality or the like (which can be referred to generally as controls) on the vaporizer, although a number of devices that may wirelessly communicate with an external controller (e.g., a smartphone, a smart watch, other wearable electronic devices, etc.) have recently become available. Control, in this context, refers generally to an ability to influence one or more of a variety of operating parameters, which may include without limitation any of causing the heater to be turned on and/or off, adjusting a minimum and/or maximum temperature to which the heater is heated during operation, various other interactive features that a user might access on a device, and/or other operations.

Various vaporizable materials having a variety of contents and proportions of such contents can be contained in the cartridge. Some vaporizable materials, for example, may have a smaller percentage of active ingredients per total volume of vaporizable material, such as due to regulations requiring certain active ingredient percentages. As such, a user may need to vaporize a large amount of vaporizable material (e.g., compared to the overall volume of vaporizable material that can be stored in a cartridge) to achieve a desired effect.

### SUMMARY

Aspects of the current subject matter relate to methods and system for manufacturing a vaporizer device. In one aspect, a vaporizer device is described. The vaporizer device may include a shell including a hermetic chamber. The hermetic chamber includes an anode, an anode current collector, a cathode, a cathode current collector, a separator, and an electrolyte disposed therein. The hermetic chamber includes the anode, the anode current collector, the cathode, the cathode current collector, and the electrolyte forming a battery serving as a power source for the vaporizer device.

In one aspect, a method of manufacturing a vaporizer device is described. The method may include disposing an anode, an anode current collector, a cathode, a cathode current collector, and a separator within a shell of the vaporizer device. The method may further include creating a hermetic chamber with the anode, the anode current collector, the cathode, the cathode current collector, and the separator disposed therein. The hermetic chamber may be formed by hermetically sealing a portion of the shell. The method may further include inserting (e.g., injecting), into the hermetic chamber, an electrolyte. The electrolyte may be inserted through an opening in the hermetic chamber.

In some variations, one or more of the following features may optionally be included in any feasible combination. The shell includes a distal end and a proximal end. The distal end is opposite of the proximal end, and the shell further includes an end cap coupled to the distal end. The separator may be interposed between the anode and the cathode. The anode, the cathode, and the separator may be wound to form a jellyroll. The jellyroll may be inserted into the shell through an opening in the distal end of the shell. The battery may further include one or more electrical contacts. The one or more electrical contacts may include a positive terminal and a negative terminal. The battery may further include a top cap coupled to the battery at a proximal end of the battery. The top cap may include a feed-through mechanism configured to couple to the one or more electrical contacts. The battery may further include a bottom cap coupled to the battery at a distal end of the battery. The distal end may be opposite of the proximal end and the bottom cap may include an opening for inserting the electrolyte into the hermetic chamber, such as by injecting the electrolyte into the hermetic chamber. The top cap may be coupled to the battery using laser welding. The laser welding may create a first seam between the shell and the top cap. The bottom cap may be coupled to the battery using the laser welding. The laser welding may further create a second seam between the shell and the bottom cap. The first seam and the second seam may form the hermetic chamber by hermetically sealing a portion of the shell between the first seam and the second seam. A venting feature may be formed through a wall of the hermetic chamber. The venting feature may be configured to allow pressure equalization between the hermetic chamber and ambient conditions while preventing passage of water or other environmental contaminants into the hermetic chamber.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings:

FIG. 1A illustrates a block diagram of a vaporizer consistent with implementations of the current subject matter;

FIGS. 1B-1F illustrate example variations of a vaporizer and cartridge assembly consistent with implementations of the current subject matter;

FIG. 1G illustrates a diagram of an identification chip of the cartridge assembly consistent with implementations of the current subject matter;

FIG. 2 illustrates example variations of a battery and shell assembly of a vaporizer consistent with implementations of the current subject matter;

FIG. 3 illustrates a jellyroll battery design consistent with implementations of the current subject matter.

FIGS. 4A-4B illustrate a perspective view and a front view of the jellyroll battery with a top cap;

FIGS. 5A-5B illustrate example variations of receptacle contacts, in accordance with one or more implementations;

FIGS. 6A-6B illustrates an assembly method for connecting the jellyroll to the top cap;

FIG. 7 illustrates an assembly method of welding a shell to the top cap consistent with implementations of the current subject matter;

FIG. 8A-8C illustrates an example assembly method for welding a bottom cap onto the shell consistent with implementations of the current subject matter;

FIGS. 9A-9B illustrate example assembly method for filling the battery with an electrolyte and sealing the bottom cap with a plug consistent with implementations of the current subject matter; and

FIGS. 10A-10C illustrate example variations of an assembly method for installing an end cap to a distal and of the shell consistent with implementations of the current subject matter.

When practical, similar reference numbers denote similar structures, features, or elements.

### DETAILED DESCRIPTION

Implementations of the current subject matter include devices relating to vaporizing of one or more materials for inhalation by a user. The term “vaporizer” is used generically in the following description to refer to a vaporizer device. Examples of vaporizers consistent with implementations of the current subject matter include electronic vaporizers, electronic cigarettes, e-cigarettes, or the like. Such vaporizers are generally portable, hand-held devices that heat a vaporizable material to provide an inhalable dose of the material.

The vaporizable material used with a vaporizer may optionally be provided within a cartridge (e.g., a part of the vaporizer that contains the vaporizable material in a reservoir or other container and that can be refillable when empty or disposable in favor of a new cartridge containing additional vaporizable material of a same or different type). A vaporizer may be a cartridge-using vaporizer, a cartridge-less vaporizer, or a multi-use vaporizer capable of use with or without a cartridge. For example, a multi-use vaporizer may include a heating chamber (e.g., an oven) configured to receive a vaporizable material directly in the heating chamber and also to receive a cartridge or other replaceable device having a reservoir, a volume, or the like for at least partially containing a usable amount of vaporizable material.

In various implementations, a vaporizer may be configured for use with liquid vaporizable material (e.g., a carrier solution in which an active and/or inactive ingredient(s) are suspended or held in solution or a neat liquid form of the vaporizable material itself) or a solid vaporizable material. A solid vaporizable material may include a plant material that emits some part of the plant material as the vaporizable material (e.g., such that some part of the plant material remains as waste after the vaporizable material is emitted for inhalation by a user) or optionally can be a solid form of the vaporizable material itself (e.g., a “wax”) such that all of the solid material can eventually be vaporized for inhalation. A liquid vaporizable material can likewise be capable of being completely vaporized or can include some part of the liquid material that remains after all of the material suitable for inhalation has been consumed.

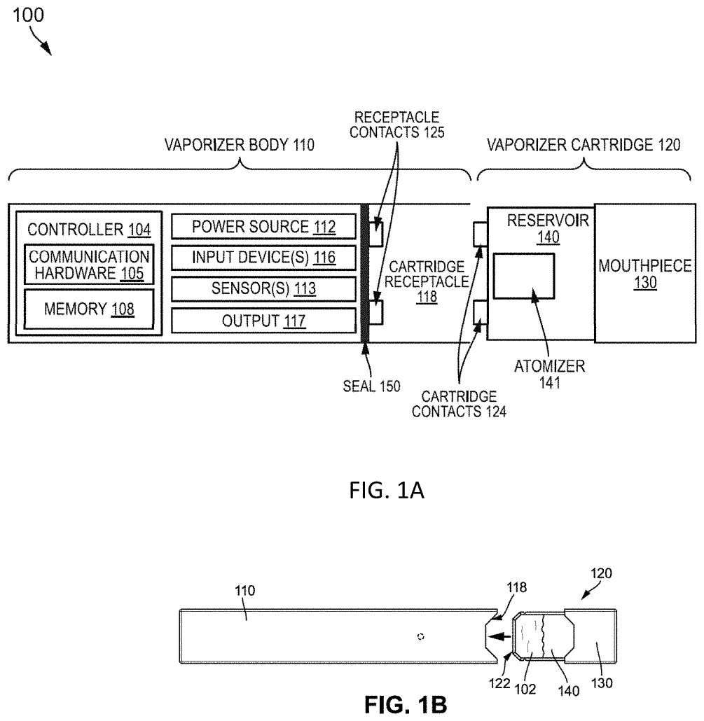

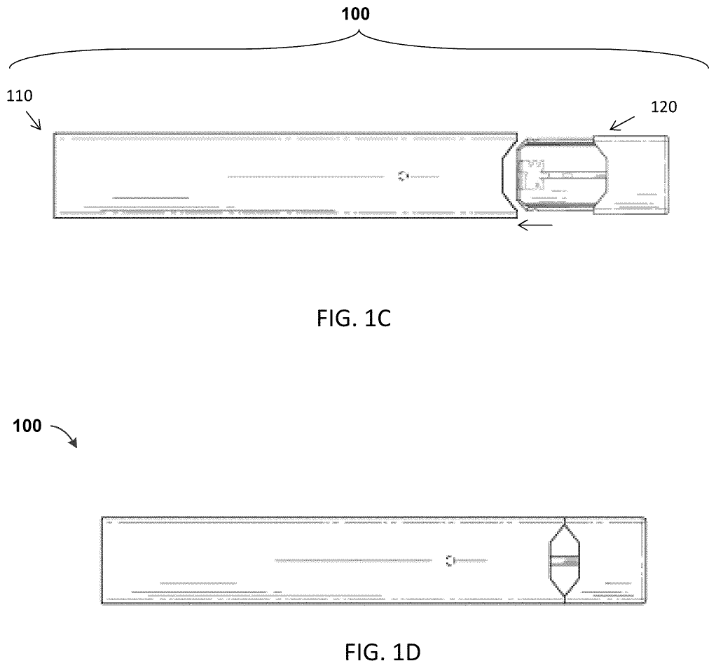

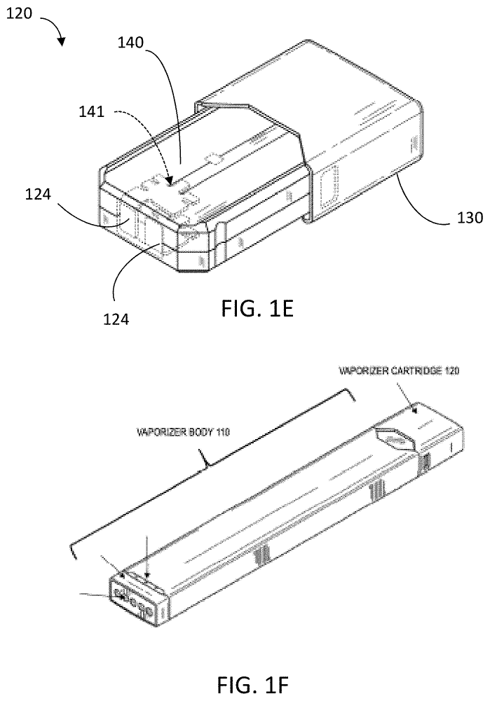

Referring to the block diagram of FIG. 1A, a vaporizer 100 typically includes a power source 112 (such as a battery which may be a rechargeable battery), and a controller 104 (e.g., a processor, circuitry, etc. capable of executing logic) for controlling delivery of heat to an atomizer 141 to cause a vaporizable material to be converted from a condensed form (e.g., a solid, a liquid, a solution, a suspension, a part of an at least partially unprocessed plant material, etc.) to the gas phase. The controller 104 may be part of one or more printed circuit boards (PCBs) consistent with certain implementations of the current subject matter.

After conversion of the vaporizable material to the gas phase, and depending on the type of vaporizer, the physical and chemical properties of the vaporizable material, and/or other factors, at least some of the gas-phase vaporizable material may condense to form particulate matter in at least a partial local equilibrium with the gas phase as part of an aerosol, which can form some or all of an inhalable dose provided by the vaporizer 100 for a given puff or draw on the vaporizer. It will be understood that the interplay between gas and condensed phases in an aerosol generated by a vaporizer can be complex and dynamic, as factors such as ambient temperature, relative humidity, chemistry, flow conditions in airflow paths (both inside the vaporizer and in the airways of a human or other animal), mixing of the gas-phase or aerosol-phase vaporizable material with other air streams, etc. may affect one or more physical parameters of an aerosol. In some vaporizers, and particularly for vaporizers for delivery of more volatile vaporizable materials, the inhalable dose may exist predominantly in the gas phase (i.e., formation of condensed phase particles may be very limited).

Vaporizers for use with liquid vaporizable materials (e.g., neat liquids, suspensions, solutions, mixtures, etc.) typically include an atomizer 141 in which a wicking element (also referred to herein as a wick (not shown in FIG. 1A), which can include any material capable of causing fluid motion by capillary pressure) conveys an amount of a liquid vaporizable material to a part of the atomizer that includes a heating element (also not shown in FIG. 1A). The wicking element is generally configured to draw liquid vaporizable material from a reservoir configured to contain (and that may in use contain) the liquid vaporizable material such that the liquid vaporizable material may be vaporized by heat delivered from a heating element. The wicking element may also optionally allow air to enter the reservoir to replace the volume of liquid removed. In other words, capillary action pulls liquid vaporizable material into the wick for vaporization by the heating element (described below), and air may, in some implementations of the current subject matter, return to the reservoir through the wick to at least partially equalize pressure in the reservoir. Other approaches to allowing air back into the reservoir to equalize pressure are also within the scope of the current subject matter.

The heating element can be or include one or more of a conductive heater, a radiative heater, and a convective heater. One type of heating element is a resistive heating element, which can be constructed of or at least include a material (e.g., a metal or alloy, for example a nickel-chromium alloy, or a non-metallic resistor) configured to dissipate electrical power in the form of heat when electrical current is passed through one or more resistive segments of the heating element. In some implementations of the current subject matter, an atomizer can include a heating element that includes resistive coil or other heating element wrapped around, positioned within, integrated into a bulk shape of, pressed into thermal contact with, or otherwise arranged to deliver heat to a wicking element to cause a liquid vaporizable material drawn by the wicking element from a reservoir to be vaporized for subsequent inhalation by a user in a gas and/or a condensed (e.g., aerosol particles or droplets) phase. Other wicking element, heating element, and/or atomizer assembly configurations are also possible, as discussed further below.

Certain vaporizers may also or alternatively be configured to create an inhalable dose of gas-phase and/or aerosol-phase vaporizable material via heating of a non-liquid vaporizable material, such as for example a solid-phase vaporizable material (e.g., a wax or the like) or plant material (e.g., tobacco leaves and/or parts of tobacco leaves) containing the vaporizable material. In such vaporizers, a resistive heating element may be part of or otherwise incorporated into or in thermal contact with the walls of an oven or other heating chamber into which the non-liquid vaporizable material is placed. Alternatively, a resistive heating element or elements may be used to heat air passing through or past the non-liquid vaporizable material to cause convective heating of the non-liquid vaporizable material. In still other examples, a resistive heating element or elements may be disposed in intimate contact with plant material such that direct conductive heating of the plant material occurs from within a mass of the plant material (e.g., as opposed to only by conduction inward form walls of an oven).

The heating element may be activated (e.g., a controller, which is optionally part of a vaporizer body as discussed below, may cause current to pass from the power source through a circuit including the resistive heating element, which is optionally part of a vaporizer cartridge as discussed below), in association with a user puffing (e.g., drawing, inhaling, etc.) on a mouthpiece 130 of the vaporizer to cause air to flow from an air inlet, along an airflow path that passes an atomizer (e.g., wicking element and heating element), optionally through one or more condensation areas or chambers, to an air outlet in the mouthpiece. Incoming air passing along the airflow path passes over, through, etc. the atomizer, where gas phase vaporizable material is entrained into the air. As noted above, the entrained gas-phase vaporizable material may condense as it passes through the remainder of the airflow path such that an inhalable dose of the vaporizable material in an aerosol form can be delivered from the air outlet (e.g., in a mouthpiece 130 for inhalation by a user).

Activation of the heating element may be caused by automatic detection of the puff based on one or more of signals generated by one or more sensors 113, such as for example a pressure sensor or sensors disposed to detect pressure along the airflow path relative to ambient pressure (or optionally to measure changes in absolute pressure), one or more motion sensors of the vaporizer, one or more flow sensors of the vaporizer, a capacitive lip sensor of the vaporizer; in response to detection of interaction of a user with one or more input devices 116 (e.g., buttons or other tactile control devices of the vaporizer 100), receipt of signals from a computing device in communication with the vaporizer; and/or via other approaches for determining that a puff is occurring or imminent.

As alluded to in the previous paragraph, a vaporizer consistent with implementations of the current subject matter may be configured to connect (e.g., wirelessly or via a wired connection) to a computing device (or optionally two or more devices) in communication with the vaporizer. To this end, the controller 104 may include communication hardware 105. The controller 104 may also include a memory 108. A computing device can be a component of a vaporizer system that also includes the vaporizer 100, and can include its own communication hardware, which can establish a wireless communication channel with the communication hardware 105 of the vaporizer 100. For example, a computing device used as part of a vaporizer system may include a general purpose computing device (e.g., a smartphone, a tablet, a personal computer, some other portable device such as a smartwatch, or the like) that executes software to produce a user interface for enabling a user of the device to interact with a vaporizer. In other implementations of the current subject matter, such a device used as part of a vaporizer system can be a dedicated piece of hardware such as a remote control or other wireless or wired device having one or more physical or soft (e.g., configurable on a screen or other display device and selectable via user interaction with a touch-sensitive screen or some other input device like a mouse, pointer, trackball, cursor buttons, or the like) interface controls. The vaporizer can also include one or more output 117 features or devices for providing information to the user.

In the example in which a computing device provides signals related to activation of the resistive heating element, or in other examples of coupling of a computing device with a vaporizer for implementation of various control or other functions, the computing device executes one or more computer instructions sets to provide a user interface and underlying data handling. In one example, detection by the computing device of user interaction with one or more user interface elements can cause the computing device to signal the vaporizer 100 to activate the heating element, either to a full operating temperature for creation of an inhalable dose of vapor/aerosol. Other functions of the vaporizer may be controlled by interaction of a user with a user interface on a computing device in communication with the vaporizer.

The temperature of a resistive heating element of a vaporizer may depend on a number of factors, including an amount of electrical power delivered to the resistive heating element and/or a duty cycle at which the electrical power is delivered, conductive heat transfer to other parts of the electronic vaporizer and/or to the environment, latent heat losses due to vaporization of a vaporizable material from the wicking element and/or the atomizer as a whole, and convective heat losses due to airflow (e.g., air moving across the heating element or the atomizer as a whole when a user inhales on the electronic vaporizer). As noted above, to reliably activate the heating element or heat the heating element to a desired temperature, a vaporizer may, in some implementations of the current subject matter, make use of signals from a pressure sensor to determine when a user is inhaling. The pressure sensor can be positioned in the airflow path and/or can be connected (e.g., by a passageway or other path) to an airflow path connecting an inlet for air to enter the device and an outlet via which the user inhales the resulting vapor and/or aerosol such that the pressure sensor experiences pressure changes concurrently with air passing through the vaporizer device from the air inlet to the air outlet. In some implementations of the current subject matter, the heating element may be activated in association with a user's puff, for example by automatic detection of the puff, for example by the pressure sensor detecting a pressure change in the airflow path.

Typically, the pressure sensor (as well as any other sensors 113) can be positioned on or coupled (e.g., electrically or electronically connected, either physically or via a wireless connection) to the controller 104 (e.g., a printed circuit board assembly or other type of circuit board). To take measurements accurately and maintain durability of the vaporizer, it can be beneficial to provide a resilient seal 150 to separate an airflow path from other parts of the vaporizer. The seal 150, which can be a gasket, may be configured to at least partially surround the pressure sensor such that connections of the pressure sensor to internal circuitry of the vaporizer are separated from a part of the pressure sensor exposed to the airflow path. In an example of a cartridge-based vaporizer, the seal 150 may also separate parts of one or more electrical connections between a vaporizer body 110 and a vaporizer cartridge 120. Such arrangements of a seal 150 in a vaporizer 100 can be helpful in mitigating against potentially disruptive impacts on vaporizer components resulting from interactions with environmental factors such as water in the vapor or liquid phases, other fluids such as the vaporizable material, etc. and/or to reduce escape of air from the designed airflow path in the vaporizer. Unwanted air, liquid or other fluid passing and/or contacting circuitry of the vaporizer can cause various unwanted effects, such as alter pressure readings, and/or can result in the buildup of unwanted material, such as moisture, the vaporizable material, etc. in parts of the vaporizer where they may result in poor pressure signal, degradation of the pressure sensor or other components, and/or a shorter life of the vaporizer. Leaks in the seal 150 can also result in a user inhaling air that has passed over parts of the vaporizer device containing or constructed of materials that may not be desirable to be inhaled.

A general class of vaporizers that have recently gained popularity includes a vaporizer body 110 that includes a controller 104, a power source 112 (e.g., battery), one more sensors 113, charging contacts 124, a seal 150, and a cartridge receptacle 118 configured to receive a vaporizer cartridge 120 for coupling with the vaporizer body through one or more of a variety of attachment structures. In some examples, vaporizer cartridge 120 includes a reservoir 140 for containing a liquid vaporizable material and a mouthpiece 130 for delivering an inhalable dose to a user. The vaporizer cartridge can include an atomizer 141 having a wicking element and a heating element (alternatively, one or both of the wicking element and the heating element can be part of the vaporizer body). In implementations in which any part of the atomizer 141 (e.g., heating element and/or wicking element) is part of the vaporizer body, the vaporizer can be configured to supply liquid vaporizer material from a reservoir in the vaporizer cartridge to the atomizer part(s) included in the vaporizer body.

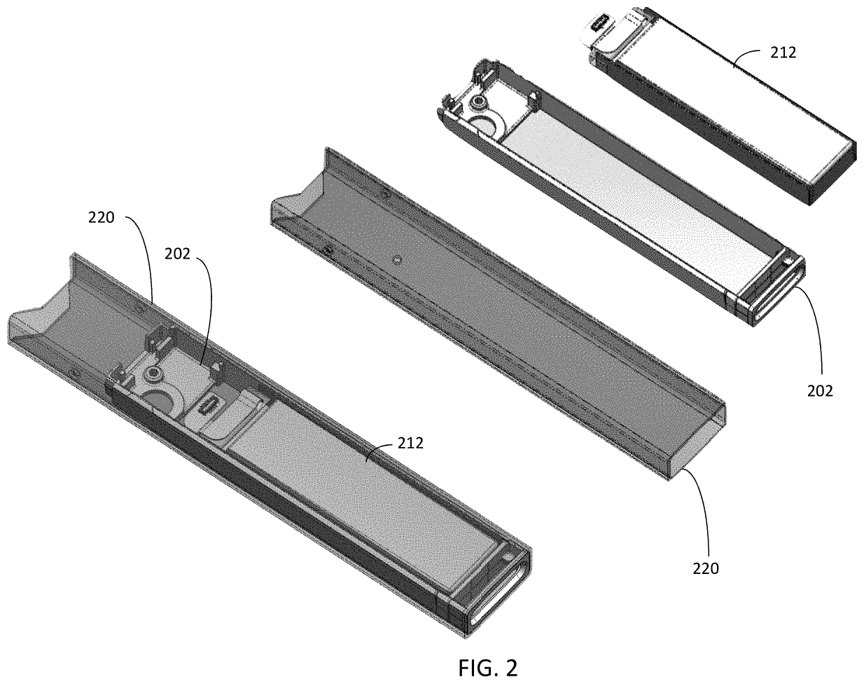

As noted, the vaporizer body 110 of the vaporizer 100 may include the power source 112. In some implementations of the current subject matter, the power source 112 may be one or more batteries including, for example, a non-rechargeable battery (or primary battery), a rechargeable battery (or secondary battery), and/or the like. To further illustrate, FIG. 2 depicts an example of the vaporizer 100 including a battery 212 and a shell 220 consistent with implementations of the current subject matter. As shown, the battery 212 may comprise a pre-manufactured battery pack contained within a pouch and/or a case. In some aspects, the battery 212 may be installed inside a skeleton 202. The skeleton 202 may be disposed inside the shell 220. As shown in the far left example of FIG. 2, the battery 212 may be disposed within the skeleton 202 and the assembly including the battery 212 and the skeleton 202 may be further disposed within the shell 220.

The vaporizer body 110 may include the shell 220 with the battery 212 installed along with other circuitry (e.g., as shown in FIG. 1A). However, with a box-in-box configuration in which the battery 212 is encased in its own container (e.g., pouch, case, and/or the like), the available space within the vaporizer body 110 may not be used with maximum efficiency at least because a portion of the space is being unoccupied by unnecessary and/or redundant structures such as the separate container for the battery 212. As such, in some implementations of the current subject matter, encasing the components of the battery 212 within a chamber of the shell 220 may reduce the quantity of wasted space within the vaporizer body 110 as well as allow for a more efficient installation of the other components of the vaporizer 100. Increasing the quantity of available space within the vaporizer body 100, including by reducing the space occupied by the non-essential components of the battery 212, may provide the space for a larger capacity battery 212 and/or additional components to achieve additional functions for the vaporizer 100. Alternatively and/or additionally, reducing the space needed to accommodate at least components of the vaporizer 100, such as the battery 212, may enable a reduction in the size of the vaporizer body 110.

Cartridge-based configurations for vaporizers that generate an inhalable dose of a non-liquid vaporizable material via heating of a non-liquid vaporizable material are also within the scope of the current subject matter. For example, a vaporizer cartridge may include a mass of a plant material that is processed and formed to have direct contact with parts of one or more resistive heating elements, and such a vaporizer cartridge may be configured to be coupled mechanically and electrically to a vaporizer body that includes a processor, a power source, and electrical contacts 125 for connecting to corresponding cartridge contacts 124 for completing a circuit with the one or more resistive heating elements.

In vaporizers in which the power source 112 is part of a vaporizer body 110 and a heating element is disposed in a vaporizer cartridge 120 configured to couple with the vaporizer body 110, the vaporizer 100 may include electrical connection features (e.g., means for completing a circuit) for completing a circuit that includes the controller 104 (e.g., a printed circuit board, a microcontroller, or the like), the power source, and the heating element. These features may include at least two contacts 124 on a bottom surface of the vaporizer cartridge 120 (referred to herein as cartridge contacts 124) and at least two contacts 125 disposed near a base of the cartridge receptacle (referred to herein as receptacle contacts 125) of the vaporizer 100 such that the cartridge contacts 124 and the receptacle contacts 125 make electrical connections when the vaporizer cartridge 120 is inserted into and coupled with the cartridge receptacle 118. The circuit completed by these electrical connections can allow delivery of electrical current to the resistive heating element and may further be used for additional functions, such as, for example, for measuring a resistance of the resistive heating element for use in determining and/or controlling a temperature of the resistive heating element based on a thermal coefficient of resistivity of the resistive heating element, for identifying a cartridge based on one or more electrical characteristics of a resistive heating element or the other circuitry of the vaporizer cartridge, etc.

As noted, the power source 112 may include one or more batteries (e.g., rechargeable batteries, non-rechargeable batteries, and/or the like), such as the battery 212, connected to a printed circuit board (PCB) forming the controller 104 of the vaporizer 100. In some aspects, the electrical terminals of the battery 212 may be exposed to external forces (e.g., contact from machine tools, jostling during transportation, external temperatures/weather, or the like) that may cause deformation or electrical shortage of the terminals. As such, in some implementations of the current subject matter, in order to prevent or reduce the effects of these external forces, the electrical terminals of the battery 212 may be positioned in different locations of the battery 212. The electrical terminals of the battery 212 may be coupled to the electrical contacts of the controller 104 (e.g., PCB).

In some examples of the current subject matter, the at least two cartridge contacts and the at least two receptacle contacts can be configured to electrically connect in either of at least two orientations. For example, one or more circuits necessary for operation of the vaporizer can be completed by insertion of a vaporizer cartridge 120 in the cartridge receptacle 118 in a first rotational orientation (around an axis along which the end of the vaporizer cartridge having the cartridge is inserted into the cartridge receptacle 118 of the vaporizer body 110) such that a first set of cartridge contacts of the at least two cartridge contacts 124 is electrically connected to a first set of receptacle contacts of the at least two receptacle contacts 125 and a second set of cartridge contacts of the at least two cartridge contacts 124 is electrically connected to a second set of receptacle contacts of the at least two receptacle contacts 125. Furthermore, the one or more circuits necessary for operation of the vaporizer can be completed by insertion of a vaporizer cartridge 120 in the cartridge receptacle 118 in a second rotational orientation such that the first set of cartridge contacts of the at least two cartridge contacts 124 is electrically connected to the second set of receptacle contacts of the at least two receptacle contacts 125 and the second set of cartridge contacts of the at least two cartridge contacts 124 is electrically connected to the first set of receptacle contacts of the at least two receptacle contacts 125. This feature of a vaporizer cartridge 120 being reversibly insertable into a cartridge receptacle 118 of the vaporizer body 110 is described further below.

In one example of an attachment structure for coupling a vaporizer cartridge 120 to a vaporizer body, the vaporizer body 110 includes a detent (e.g., a dimple, protrusion, etc.) protruding inwardly from an inner surface the cartridge receptacle 118. One or more exterior surfaces of the vaporizer cartridge 120 can include corresponding recesses (not shown in FIG. 1A) that can fit and/or otherwise snap over such detents when an end of the vaporizer cartridge 120 inserted into the cartridge receptacle 118 on the vaporizer body 110. When the vaporizer cartridge 120 and the vaporizer body 110 are coupled (e.g., by insertion of an end of the vaporizer cartridge 120 into the cartridge receptacle 118 of the vaporizer body 110), the detent into the vaporizer body 110 may fit within and/or otherwise be held within the recesses of the vaporizer cartridge 120 to hold the vaporizer cartridge 120 in place when assembled. Such a detent-recess assembly can provide enough support to hold the vaporizer cartridge 120 in place to ensure good contact between the at least two cartridge contacts 124 and the at least two receptacle contacts 125, while allowing release of the vaporizer cartridge 120 from the vaporizer body 110 when a user pulls with reasonable force on the vaporizer cartridge 120 to disengage the vaporizer cartridge 120 from the cartridge receptacle 118.

Further to the discussion above about the electrical connections between a vaporizer cartridge and a vaporizer body being reversible such that at least two rotational orientations of the vaporizer cartridge in the cartridge receptacle are possible, in some vaporizers the shape of the vaporizer cartridge, or at least a shape of the end of the vaporizer cartridge that is configured for insertion into the cartridge receptacle may have rotational symmetry of at least order two. In other words, the vaporizer cartridge or at least the insertable end of the vaporizer cartridge may be symmetric upon a rotation of 180° around an axis along which the vaporizer cartridge is inserted into the cartridge receptacle. In such a configuration, the circuitry of the vaporizer may support identical operation regardless of which symmetrical orientation of the vaporizer cartridge occurs. In some aspects, the first rotational position may be more than or less than 180° from the second rotational position.

In some examples, the vaporizer cartridge, or at least an end of the vaporizer cartridge configured for insertion in the cartridge receptacle may have a non-circular cross section transverse to the axis along which the vaporizer cartridge is inserted into the cartridge receptacle. For example, the non-circular cross section may be approximately rectangular, approximately elliptical (e.g., have an approximately oval shape), non-rectangular but with two sets of parallel or approximately parallel opposing sides (e.g., having a parallelogram-like shape), or other shapes having rotational symmetry of at least order two. In this context, approximately having a shape indicates that a basic likeness to the described shape is apparent, but that sides of the shape in question need not be completely linear and vertices need not be completely sharp. Rounding of both or either of edges or vertices of the cross-sectional shape is contemplated in the description of any non-circular cross section referred to herein.

FIG. 1B illustrates an embodiment of the vaporizer device body 110 having a cartridge receptacle 118 into which the cartridge 120 may be releasably inserted. FIG. 1B shows a top view of the vaporization device 100 illustrating the cartridge 120 being positioned for insertion into the vaporizer device body 110. When a user puffs on the vaporization device 100, air may pass between an outer surface of the cartridge 120 and an inner surface of a cartridge receptacle 118 on the vaporizer device body 110. Air can then be drawn into an insertable end 122 of the cartridge, through the vaporization chamber that includes or contains the heating element and wick, and out through an outlet of the mouthpiece 130 for delivery of the inhalable aerosol to a user. The reservoir 140 of the cartridge 120 may be formed in whole or in part from translucent material such that a level of vaporizable material 102 is visible along the cartridge 120.

FIGS. 1C and 1D show top views before and after connecting a cartridge 120 to a vaporizer body 110. FIG. 1E shows a perspective view of one variation of a cartridge 120 holding a liquid vaporizable material. In general, when a vaporizer includes a cartridge (such as the cartridge 120), the cartridge 120 may include one or more reservoirs 140 of vaporizable material. Any appropriate vaporizable material may be contained within the reservoir 140 of the cartridge 120, including solutions of nicotine or other organic materials.

FIGS. 1B to 1E illustrate an example of a vaporizer 100 with a vaporizer body 110 and cartridge 120. Vaporizer body 110 and cartridge 120 are shown unconnected in FIGS. 1B and 1C and connected in FIG. 1D. FIG. 1D shows a perspective view of the combined vaporizer body 110 and cartridge 120, and FIG. 1E shows an individual cartridge 120. FIGS. 1B-1E illustrate an example including many of the features generally shown in FIG. 1A. Other configurations, including some or all of the features described herein, are also within the scope of the current subject matter.

The at least two cartridge contacts 124 and the at least two receptacle contacts 125 can take various forms. For example, one or both sets of contacts may include conductive pins, tabs, posts, receiving holes for pins or posts, or the like. Some types of contacts may include springs or other spring features to cause better physical and electrical contact between the contacts on the vaporizer cartridge and the vaporizer body. The electrical contacts may optionally be gold-plated, and/or can include other materials.

As noted, in some implementations of the current subject matter, the battery 212 may be encased in the shell 220 of the vaporizer body 110 instead of a separate container (e.g., pouch, case, and/or the like). Doing so may avoid the box-in-box configuration shown in FIG. 2 in which at least some of the available space within the vaporizer body 100 is used to accommodate a separate container (e.g., pouch, case, and/or the like) for the battery 212. Encasing the components of the battery 212 within a chamber of the shell 220 consistent with implementations of the current subject matter may reduce the space occupied by the non-essential components of the battery 212, thereby increasing the quantity of available space within the vaporizer body 100 and/or reducing the size of the vaporizer body 100. Additionally, a case for the battery that is formed as an integral part of the shell 220 can in some embodiments provide a more robust seal for the internal materials of the battery than is typical with a pouch-encased battery. Furthermore, formation of the battery encasing structure as part of the manufacture of the shell 220 may allow for formation of a venting feature (e.g., a membrane or a valve that is permeable to gases but not to water or other environmental contaminants) that can be manufactured with more controlled tolerances than would be attainable with a flexible pouch battery encasement. Such a venting feature may provide benefits in allowing pressure equalization between the battery encasement and ambient pressure conditions.

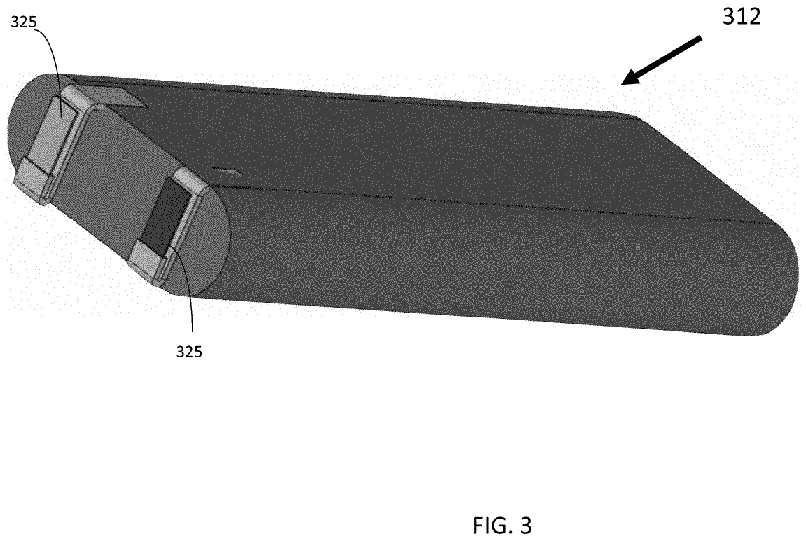

In some implementations of the current subject matter, the battery 212 may include a jellyroll 312 and one or more battery contacts 325. FIG. 3 illustrates an example of the jellyroll 312 consistent with implementations of the current subject matter. As shown in FIG. 3, the jellyroll 312 may be coupled with one or more battery contacts 325 at a proximal end of the jellyroll 312. Moreover, the jellyroll 312 may include the active components of the battery 212, such as alternating layers of an anode material and a cathode material along with an intervening separator layer. In some aspects, the anode layers may include an anode current collector coupled to an anode layer and the cathode layers may include a cathode current collector coupled to a cathode layer. In some implementations, a first battery contact 325A may be coupled to the anode current collector while a second battery contact 325B may be coupled to the cathode current collector. The anode and/or the cathode current collectors may include copper and/or aluminum foils. The active materials may be coated on the surface of the current collectors before being wound together with the separator interposed therebetween to form the jellyroll 312. The current collectors may be positioned within the jellyroll 312 or may be positioned outside the jellyroll 312. Electrical current may flow between the cathode and anode current collectors.

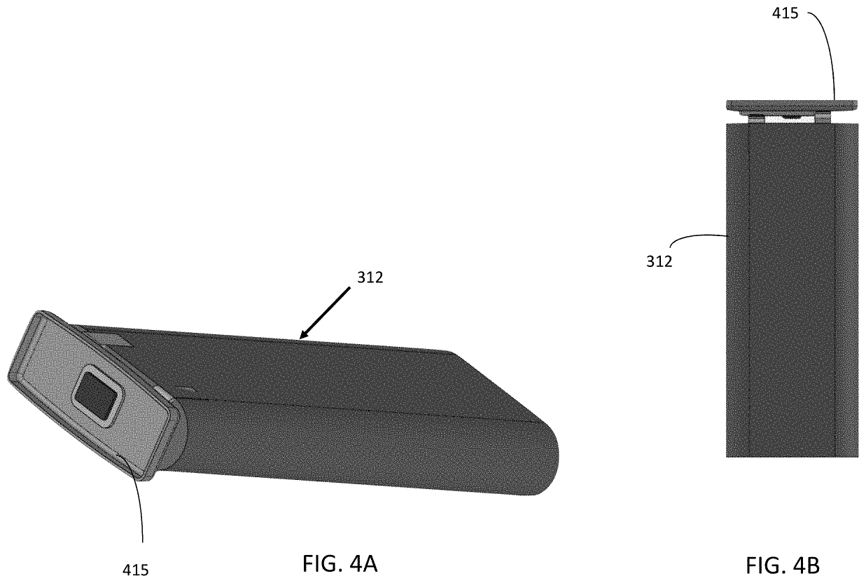

FIGS. 4A-B illustrate a perspective view and a front view of the jellyroll 312 with a top cap 415. In some aspects, the top cap 415 has a top side and a bottom side. The bottom side may be coupled to the one or more battery contacts 325 at the proximal end of the jellyroll 312. The top side may include an electrical connection configured to provide power to electrical components of the vaporizer body 110.

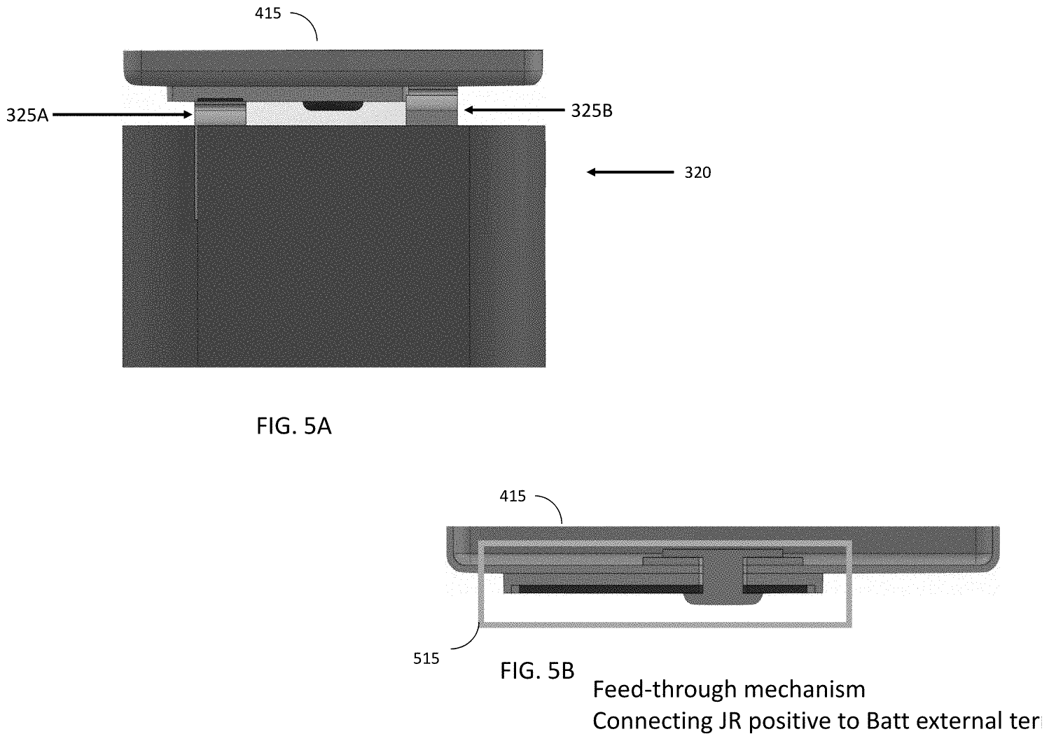

FIGS. 5A-B illustrate example variations of the top cap 415 coupled to the jellyroll 312, in accordance with one or more implementations. FIG. 5A shows a close-up view of a proximal end 320 of the jellyroll 312. As shown, the proximal end 320 may include the first electrical contact 325A and the second electrical contact 325B. In some aspects, the first electrical contact 325A may include a positive terminal of the jellyroll 312 and the second electrical contact 325B may include a negative terminal of the jellyroll 312. As further shown, the top cap 415 may be coupled to the first electrical contact 325A and the second electrical contact 325B. FIG. 5B shows a cross-section of the top cap 415. As shown in FIG. 5B, the top cap 415 includes a feedthrough mechanism 515 configured to couple to the jellyroll 312 via the first electrical contact 325A and the second electrical contact 325B. In some implementations, the top cap 415 may be coupled to the jellyroll 312 via welding (e.g., laser welding). In some aspects, the feedthrough mechanism 515 may be configured to connect the jellyroll 312 positive terminal to an external terminal of the power source 112 (e.g., an external terminal of a battery pack) and may be configured to provide an electrical connection from the battery 212 through the top cap 415.

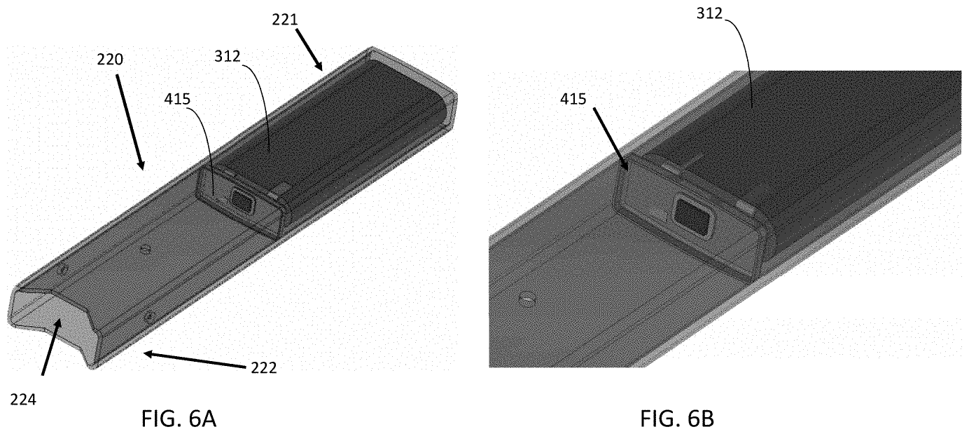

FIGS. 6A-B illustrate example variations of an assembly method for installing a jellyroll 312 and top cap 415 assembly into the shell 220 consistent with implementations of the current subject matter. FIG. 6A shows the jellyroll 312 and top cap 415 assembly installed at a distal end 221 of the shell 220. As shown, the shell 220 further comprises a proximal end 222 having an opening 224. FIG. 6B shows a perspective close-up view of the jellyroll 312 and top cap 415 installed within the shell 220. In some implementations, the proximal end 222 may include an opening sized and configured to receive the jellyroll 312 and top cap 415 assembly.

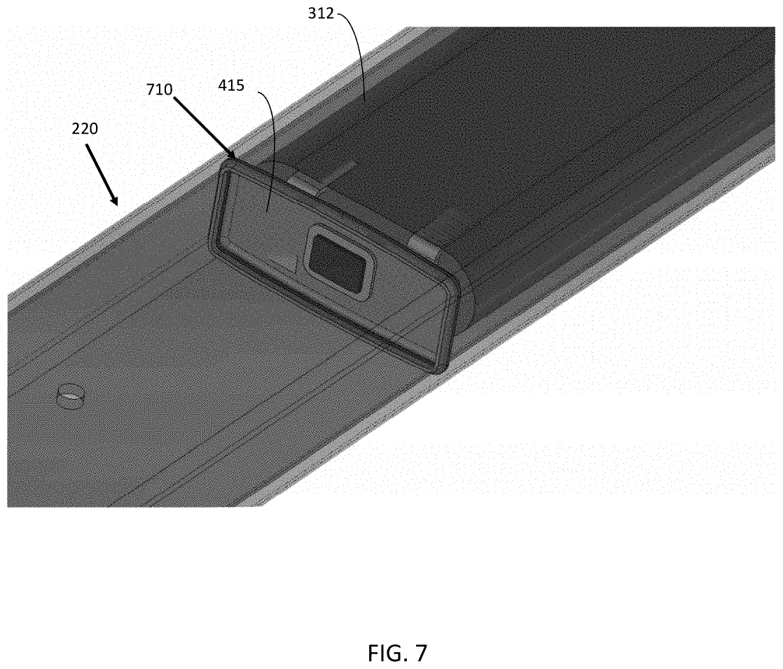

FIG. 7 illustrates an assembly method of welding the shell 220 to the top cap 415 consistent with implementations of the current subject matter. As shown in FIG. 7, the top cap 415 may be welded (e.g., laser welding) to the shell 220 and create a seam 710 coupling the top cap 415 to the shell 220 and sealing the jellyroll 312 inside a portion of the shell 220. This seal may prevent battery fluid from contaminating other portions or components of the vaporizer body 110.

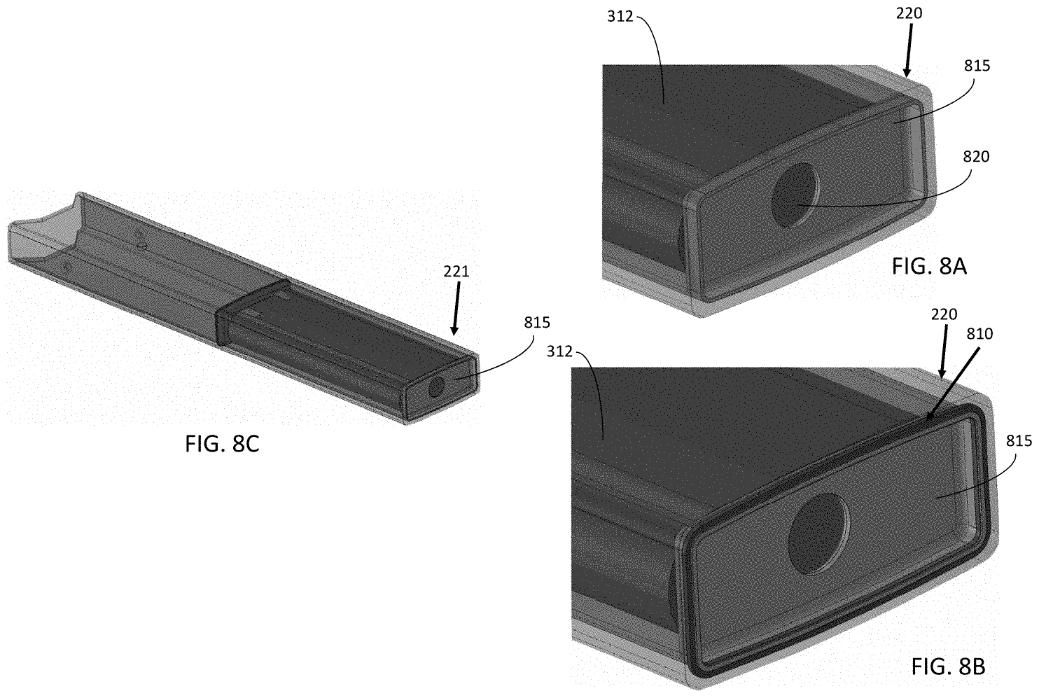

FIG. 8A-8C illustrates an example assembly method for welding a bottom cap 815 to the shell 220 consistent with implementations of the current subject matter. FIG. 8A shows the bottom cap 815 coupled to a distal side of the jellyroll 312. As shown, the bottom cap 815 includes an opening 820. FIG. 8B shows the bottom cap 815 welded to the shell 220 creating a seam 810. In some aspects, the first seam 710 and the second seam 810 may define a hermetic chamber for holding the power source 112 (e.g., a battery) of the vaporizer device.

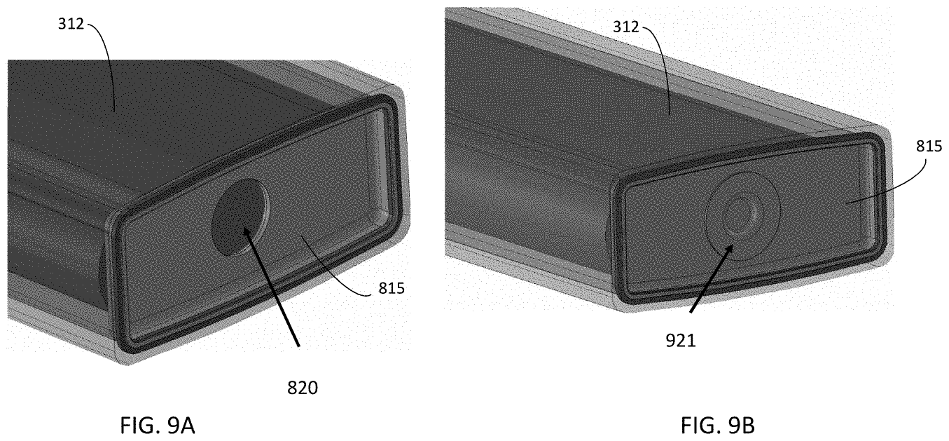

FIGS. 9A-9B illustrate an example assembly method for filling the chamber, defined by the seams 710 and 810 and holding the jellyroll 312, with a liquid electrolyte or gel electrolyte and sealing the bottom cap 815 with a plug 921 consistent with implementations of the current subject matter. For example, FIG. 9A shows that a liquid electrolyte or a gel electrolyte may be injected or inserted through the opening 820. FIG. 9B shows a plug 921 installed over the opening 820. In some aspects, the plug 921 may be laser welded or otherwise coupled to the bottom cap 815. In some implementations, the plug 921 may seal the electrolyte fluid in the chamber containing the jellyroll 312 and may prevent any electrolyte fluid from escaping the chamber created by the seams 710 and 810.

Although FIGS. 9A-9B depicts the jellyroll 312 as being filled with a liquid electrolyte or a gel electrolyte, it should be appreciated that in other implementations of the current subject matter, the jellyroll 312 may include a solid state electrolyte. The solid state electrolyte may be included in the jellyroll 312. For example, the solid state electrolyte may be interposed between the anode and the cathode of the jellyroll 312 as part of the separator.

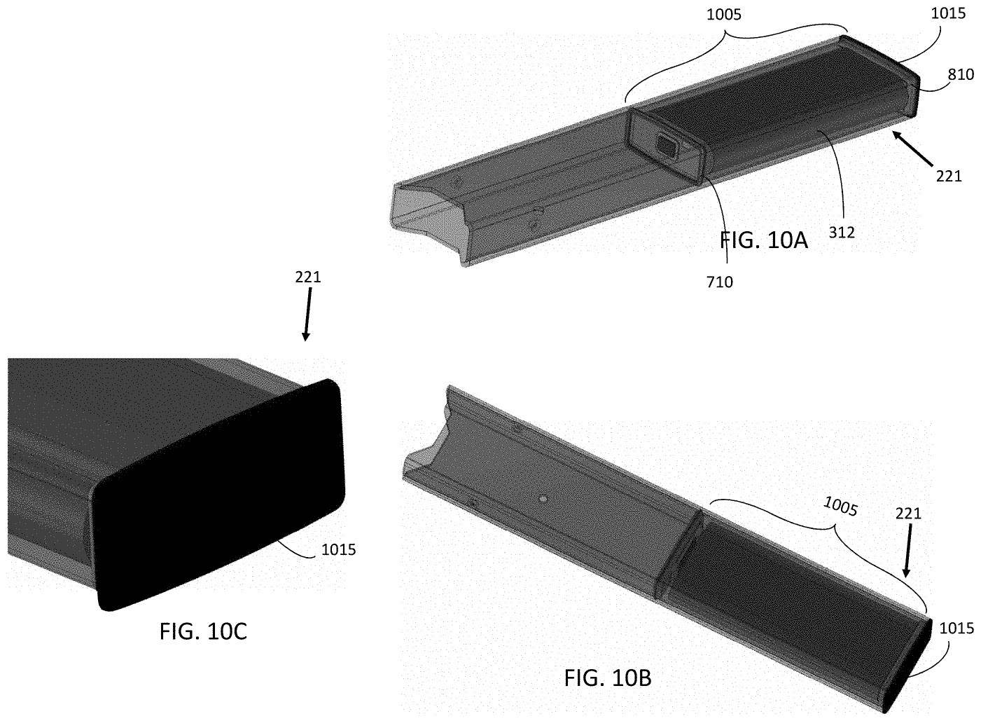

FIGS. 10A-10C illustrate example variations of an assembly method for installing an end cap 1015 to the distal end 221 of the shell 220 consistent with implementations of the current subject matter. In some aspects, the end cap 1015 may provide a further seal to the bottom cap 815. FIG. 10A shows a hermetic chamber 1005 defined by seams 710 and 810. As shown in FIG. 10A, the hermetic chamber 1005 includes the jellyroll 312 and any electrolyte inserted through the opening 820 (if any). As further shown in FIGS. 10A-10C, the end cap 1015 may be installed at the distal end 221 of the shell 220 and at the distal end of the jellyroll 312.

### Terminology

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present.

Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments and implementations only and is not intended to be limiting. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

Spatially relative terms, such as “forward”, “rearward”, “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings provided herein.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the teachings herein. For example, the order in which various described method steps are performed may often be changed in alternative embodiments, and in other alternative embodiments, one or more method steps may be skipped altogether. Optional features of various device and system embodiments may be included in some embodiments and not in others. Therefore, the foregoing description is provided primarily for exemplary purposes and should not be interpreted to limit the scope of the claims.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A vaporizer device comprising:
a shell including a hermetic chamber, the hermetic chamber having an anode, an anode current collector, a cathode, a cathode current collector, a separator, and an electrolyte disposed therein, and the hermetic chamber including the anode, the anode current collector, the cathode, the cathode current collector, and the electrolyte forming a battery serving as a power source for the vaporizer device.

2. The vaporizer device of claim 1, wherein the shell comprises a distal end and a proximal end, wherein the distal end is opposite of the proximal end, and wherein the shell further comprises an end cap coupled to the distal end.

3. The vaporizer device of claim 1, wherein the separator is interposed between the anode and the cathode, and wherein the anode, the cathode, and the separator are wound to form a jellyroll.

4. The vaporizer device of claim 1, wherein the jellyroll is inserted into the shell through an opening in the distal end of the shell.

5. The vaporizer device of claim 1, wherein the battery further comprises one or more electrical contacts.

6. The vaporizer device of claim 1, wherein the one or more electrical contacts include a positive terminal and a negative terminal.

7. The vaporizer device of claim 1, wherein the battery further comprises:
a top cap coupled to the battery at a proximal end of the battery, the top cap having a feed-through mechanism configured to couple to the one or more electrical contacts, and
a bottom cap coupled to the battery at a distal end of the battery, the distal end opposite of the proximal end, and the bottom cap having an opening for injecting the electrolyte into the hermetic chamber.

8. The vaporizer device of claim 1, wherein the top cap is coupled to the battery using laser welding, and wherein the laser welding creates a first seam between the shell and the top cap.

9. The vaporizer device of claim 1, wherein the bottom cap is coupled to the battery using the laser welding.

10. The vaporizer device of claim 1, wherein the laser welding further creates a second seam between the shell and the bottom cap, and wherein the first seam and the second seam form the hermetic chamber by hermetically sealing a portion of the shell between the first seam and the second seam.

11. The vaporizer device of claim 1, further comprising a venting feature formed through a wall of the hermetic chamber, the venting feature configured to allow pressure equalization between the hermetic chamber and ambient conditions while preventing passage of water or other environmental contaminants into the hermetic chamber.

12. A method of manufacturing a vaporizer device, the method comprising:
disposing an anode, an anode current collector, a cathode, a cathode current collector, and a separator within a shell of the vaporizer device;
creating a hermetic chamber with the anode, the anode current collector, the cathode, the cathode current collector, and the separator disposed therein, the hermetic chamber formed by hermetically sealing a portion of the shell; and
injecting, into the hermetic chamber, an electrolyte, the electrolyte being injected through an opening in the hermetic chamber.

13. The method of claim 12, wherein creating the hermetic chamber comprises:
laser welding a top cap to the shell, the laser welding creating a first seam between the shell and the top cap; and
laser welding a bottom cap to the shell, the laser welding creating a second seam between the shell and the bottom cap, the first seam and the second seam forming the hermetic chamber by hermetically sealing a portion of the shell between the first seam and the second seam.

14. The method of claim 12, wherein the creating of the hermetic chamber further comprises welding a plug to cover the opening subsequent to injecting the electrolyte.

15. The method of claim 12, further comprising installing a plug over the opening.

16. The method of claim 12, wherein the opening is disposed on the bottom cap.

17. The method of claim 12, wherein installing the plug comprises laser welding the plug to the opening on the bottom cap.

18. The method of claim 12, wherein the shell comprises a distal end and a proximal end, wherein the distal end is opposite of the proximal end, and wherein the shell further comprises an end cap coupled to the distal end.

19. The method of claim 12, wherein the separator is interposed between the anode and the cathode, and wherein the anode, the cathode, and the separator are wound to form a jellyroll.

20. The method of claim 13, further comprising:
coupling the top cap to the jellyroll at a proximal end of the jellyroll, the top cap having a feed-through mechanism configured to couple to one or more electrical contacts;
inserting the jellyroll into the shell through an opening in the distal end of the shell; and
forming a venting feature through a wall of the hermetic chamber, the venting feature configured to allow pressure equalization between the hermetic chamber and ambient conditions while preventing passage of water or other environmental contaminants into the hermetic chamber.

21. (canceled)

22. (canceled)
